(19) United States
(12) Patent Application Publication
(10) Pub. No.: US 2008/0312982 A1
(43) Pub. Date: Dec. 18, 2008

(54) Dynamic Creation of a Service Model

(75) Inventors: Alan D. Braun, Morris Plains, NJ (US); Isaac J. Graf, Flushing, NY (US); Shoel D. Perelman, New York, NY (US)

Correspondence Address: DILLON & YUDELL LLP, 8911 N. CAPITAL OF TEXAS HWY., SUITE 2110, AUSTIN, TX, 78759, US

(73) Assignee: International Business Machine Corporation, Armonk, NY (US)

(21) Appl. No.: 11/763,547

(22) Filed: Jun. 15, 2007

(51) Int. Cl. G06F 9/44

(52) U.S. Cl. 705/7

(57) ABSTRACT

A service model of resources is dynamically created from a selected service model template. A user-input or incoming event selects one of multiple pre-defined service model templates for construction of a selected service model. The selected service model represents real-time characteristics of resources for an enterprise. External data sources, which are used to describe the real-time characteristics of the depicted resources, are then identified, and the service model is constructed using the identified external data sources.

### BACKGROUND OF THE INVENTION

The present disclosure relates to the field of computers, and specifically to software. Still more specifically, the present disclosure relates to dynamically creating a service model of computing resources.

Enterprises utilize many resources, including computing resources, which include hardware, software and personnel. Often, such resources are layer dependent. For example, a particular software application may support the needs of a particular enterprise department, while hardware resources such as a server farm may support the execution of the particular software application.

### BRIEF SUMMARY OF THE INVENTION

A service model of resources is dynamically created from a selected service model template. A user-input or an incoming event causes the selection of one of multiple pre-defined service model templates for construction of a selected service model. The selected service model represents real-time characteristics of resources for an enterprise. External data sources, which are used to describe the real-time relationships and characteristics of the depicted resources, are then identified, and the service model is constructed using the identified external data sources.

The above as well as additional objectives, features, and advantages of the present invention will become apparent in the following detailed written description.

### BRIEF DESCRIPTION OF THE SEVERAL VIEWS OF THE DRAWINGS

The invention itself will best be understood by reference to the following detailed description of an illustrative embodiment when read in conjunction with the accompanying drawings, wherein:

FIG. 1 depicts an exemplary computer in which the present invention may be implemented;

FIG. 2 illustrates a relationship among resources depicted in a service model that has been constructed in accordance with the present disclosure;

FIG. 3 depicts logic found within a service model construction logic that is used to construct the service model depicted in FIG. 2;

FIG. 4 is a flow-chart of exemplary steps taken to construct the service model shown in FIG. 2; and

FIG. 5 depicts how parent and child resources to a depicted seed resource can be visualized.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

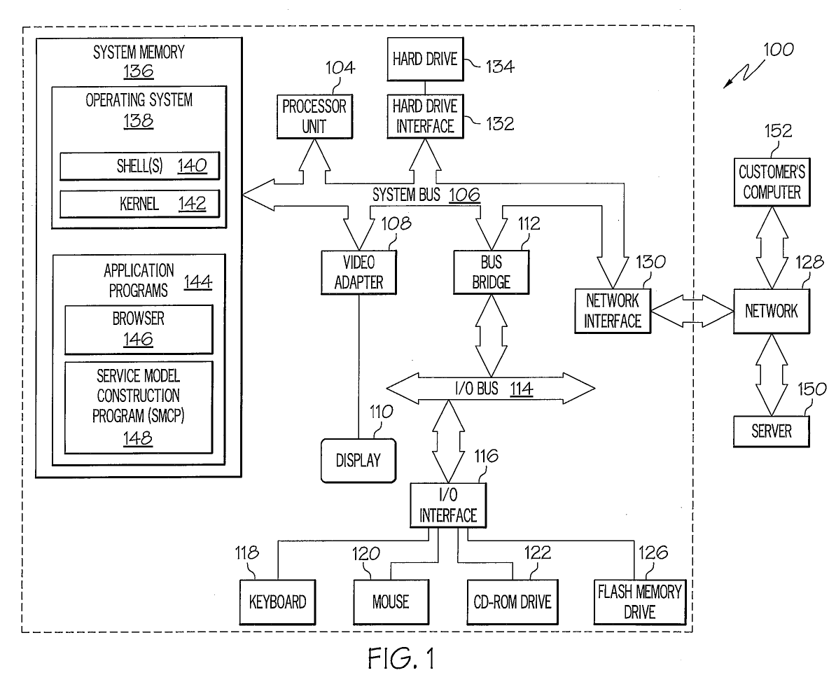

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 and/or a customer's computer 152 via a network 128 using a network interface 130, which is coupled to system bus 106. Network 128 may be an external network such as the Internet, or an internal network such as an Ethernet or a Virtual Private Network (VPN). Server 150 and customer's computer 152 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

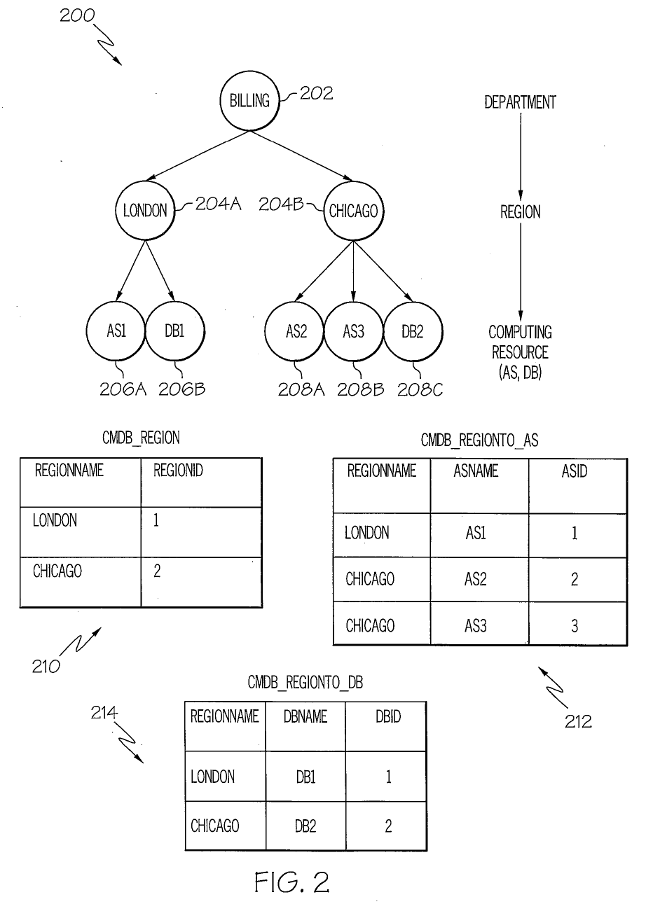

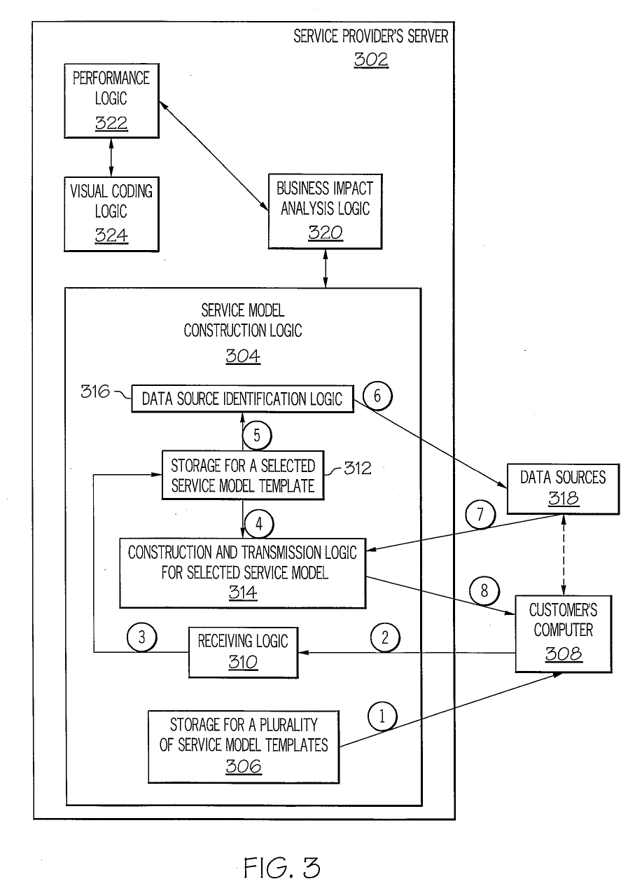

Application programs 144 include a browser 146. Browser 146 includes program modules and instructions enabling a World Wide Web (WWw) client (i.e., computer 100) to send and receive network messages to the Internet. Computer 100 may utilize HyperText Transfer Protocol (HTTP) messaging to enable communication with server 150. Application programs 144 in system memory 136 also include a Service Model Construction Program (SMCP) 148. SMCP 148 performs the functions illustrated below in FIGS. 2-5, and may include software components of the Service Model Construction Logic 304, Business Impact logic 320, performance logic 322 and visual coding logic 324 shown below in FIG. 3.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, a service model 200, which is constructed in accordance with the process described herein, is depicted. Service model 200 includes multiple layers of resources, including those shown for exemplary purposes as a department level, a region level, and a computing resources level. The department level includes a billing department 202, which has offices in the London region (204a) and the Chicago region (204b). Each department and region can be quantified (e.g., through performance data such as sales figures, customer satisfaction levels, etc.) for creation of the service model 200. As depicted, London region 204a has access to an Application Server (AS1) 206a and a Database (DB1) 206b. Similarly, the Chicago region has access to two Application servers (AS2—208a; AS3—208b) and a database (DB2—208c).

The relationship between the departments, regions and computing resources are depicted in tables 210, 212 and 214. These tables may be stored in data sources, such as the data sources 318 describe below in FIG. 3.

Referring now to FIG. 3, a relationship among a service provider's server 302 (e.g., computer 100 shown in FIG. 1), data sources 318 and a customer's computer 308 (e.g., customer computer 152) is depicted. Also depicted is an exemplary set of steps that are taken to create a service model in accordance with the present disclosure.

Within the service provider's server 302 is a service model construction logic 304. Service model construction logic 304 includes a storage 306, which holds a plurality of service model templates. These service model templates provide a general organizational framework for describing a relationship among resources, including computing resources, departments, personnel, etc., for an enterprise. Each service model template includes a set of rules that map each resource that is to be depicted in the service model to one or more external data sources. Similarly, each service model template includes a set of rules that define characteristics of the resources, such as how dependencies should be created between a given resource that is assigned to the template and all the children and parents of this resource that should exist in the model. Note also that a single resource may be part of many different service model templates. Some or all of these templates are sent to the customer's computer 308 (Step 1). The customer (or intelligent software logic within customer's computer 308) selects one or more of the service model templates, and sends the selected service model template(s) to a receiving logic 310 within the service model construction logic 304 (Step 2). The selected service model template is then sent to a storage 312 (Step 3), which forwards the selected service model template to a construction and transmission logic 314 (Step 4) and a data source identification logic 316 (Step 5). The data source identification logic 316 poll an appropriate data source from the data sources 318 (Step 6). Data source identification logic 316 can also be configured to query the data sources 318 only when specifically required to do so, either by the user requesting to view a section of the model or by an event that comes in that requires construction of the section of the model that is affected by the event. The requisite data is then sent to the construction and transmission logic 314 (Step 7). The construction and transmission logic 314 then creates a service model that accurately represents the resources of the customer, and sends this newly created service model to the customer's computer 308 (Step 8). Note that the construction and transmission logic 314 can cache data for the newly created service model, such that sections of the newly created service model can be re-created on-the-fly for transmission to the customer.

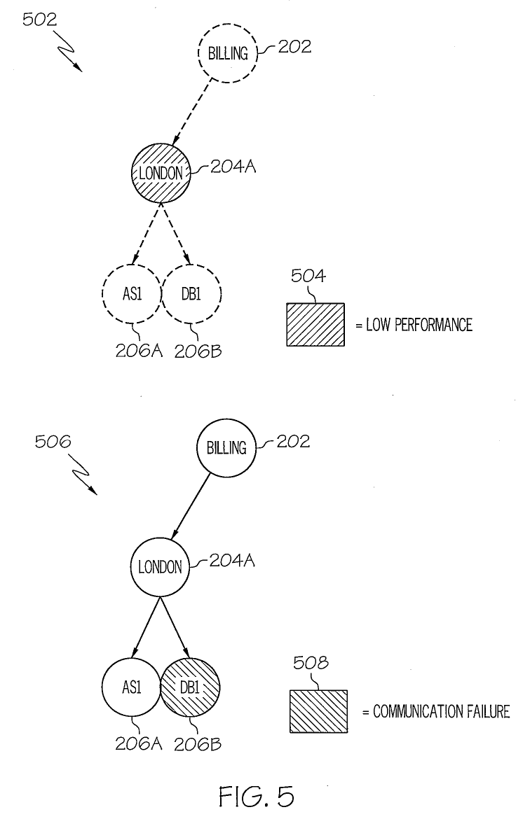

A business impact analysis logic 320 can analyze the health of an enterprise's resources by using the newly created service model. For example, a performance logic 322 can compare how well a resource is or is not performing when compared to a predefined benchmark, which is found in the data sources 318. In one embodiment, these data sources 318 are a Configuration Management Database (CMDB) that may be (as suggested by the dotted line) directly managed by the customer using the customer's computer 308. These benchmarks, as well as other data needed to define the operation, relationship to other resources, and other parameters for describing a particular resource may be obtained by a Structured Query Language (SQL) query from the service model construction logic 304 to the CMDB data sources 318. Alternatively, the external data source may be from a web service. In either scenario, logic (e.g., data source identification logic 316) configures a policy that obtains both children and/or parents of seed data sources, rather than simply making a standard database query. As described in FIG. 5, each depicted resource can be visually coded (e.g., color coded, shaded, etc.) to indicate how well it is performing.

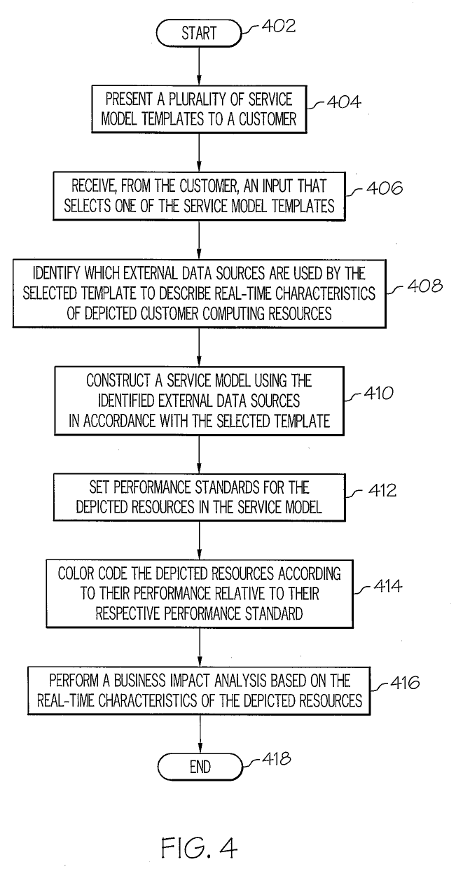

A more detailed description of the process described in FIG. 3 is shown in the flow-chart of FIG. 4. After initiator step 402, which may be prompted by a message from a customer's computer asking that a service model of the customer's resources be created, a plurality of service model templates are presented to the customer (block 404). The customer selects which service model template(s) he wants (block 406), which allows the service provider to identify which external data sources are needed to describe real-time characteristics of the resources to be depicted in a newly created service model for the customer (block 408). The service model is created (block 410), showing all resources described by the identified external data sources.

In a preferred embodiment, the service model is constructed one level at a time. This can happen recursively going down or up (in lower or higher levels of) the service hierarchy. When the program needs to determine the children of a particular resource, the program will execute the rules configured for the templates of that seed resource to obtain the set of data necessary to construct the children. Each rule also specifies which templates should be assigned to these new resources, and also assigns field/value pairs and a unique name to the new resources based on external data that is their precursor. In addition, the new resources will inherit the properties of their parent. The templates assigned to the new resources may be preconfigured with their own dynamic rules, so that when the new resources are asked for their children, the rules in their templates will be invoked, and any queries executed may be parameterized by the properties configured in these resources. (For example, the query in the rule may require some identifier of the seed resource to filter out non-relevant resources from getting imported as children. This identifier may be set as a property of the seed resource when the seed resource was itself created from an external set of data.) This described entire procedure will also be followed when building the model from bottom up, as when events come in to populate as-yet unbuilt sections of the service model. Note in one embodiment that the input that selects a service model template may be a user-driven action (e.g., a user manually selecting a template from a list displayed in a GUI), or the input may be an event from a plurality of data sources. For example, when the data sources change, this event may be noted by the construction and transmission logic 314 shown in FIG. 3, which will result in the automatic construction and/or updating of the service model. The service model can be continuously updated by re-running dependency rules configured in the templates when requested by the customer (user) or at a configurable polling interval (during which time period the status of, including any changes to, the data sources may be determined and updated). This will result in the adding and removing of new resources and relationships to the service mode, thus reflecting the current status of the external data sources.

Another feature of the dynamic discovery method utilized herein is that models discovered (created) can integrate seamlessly with models created manually or programmatically via external Application Program Interfaces (APIs). These resources can be referred to as static resources. Relationships can be assigned manually or programmatically between resources created via dynamic lookups and static resources. Manually created relationships are not subject to change when the external data changes.

As depicted in block 412, performance standards for each resource depicted in the service model may be set. These performance standards may be for software (e.g., error rates, throughput, etc.), hardware (e.g., processing times, memory page faults caused by needed data not being stored in cache, etc.) or personnel (e.g., excessive absenteeism, failure to meet sales quotas, etc.). If a resource meets, exceeds, or fails to meet a predetermined performance standard, this condition can be represented by visually coding the particular resource's depiction in the service model (block 414). Utilizing such visual coding is useful to a manager, or a performance software, when performing a business impact analysis based on the performance of various depicted enterprise resources (block 416). The process ends at terminator block 418.

Different resources may be hidden if they, or their seed resource, are functioning within normal parameters, or if the seed resource has not been called for a specified period of time. For example, consider the partial service model 502 shown in FIG. 5. Initially, only the resource 204a, which depicts the London office of the billing department is shown in a Graphical User Interface (GUI) on a display (e.g., display 110 shown in FIG. 1) of the customer's computer (e.g., customer's computer 308 shown in FIG. 3). As suggested by legend 504, the London office is performing poorly. Initially, the parent department (billing 202) and the computing resources (206a-b) are not depicted in the GUI. However, by clicking on the depiction of the London office (204a), the parent department (billing 202) and the computing resources (206a-b) are displayed. As suggested by legend 508, the problem appears to be caused by a communication failure between the London office 204a and the Database DB1 (206b). A manager (or automatic software logic) can then take the appropriate steps to correct the problem. Note that the visual coding may be based on scoring data, which can be viewed independently of the visual coding in a table form, in order to provide the evaluator additional information regarding the cause of the low performance of the London office.

The fact that dynamic model discovery (and creation) will only import sections of a service model that are relevant to the customer (i.e. that the user selects to view or that are affected by an event) can have significant benefit to product scalability. This can result in large sections of a service model remaining outside the program's constructed model, resulting in a much smaller memory footprint, and thus producing enhanced processing speed.

Note again that the initial presentation of the London office (204a) may be in response to an anomaly (i.e., under-performance, over-performance, etc.), or a manager may simply call up the desired resource (seed resource) to see how its parent(s) and children are behaving.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for dynamically creating a service model, the method comprising:
presenting a plurality of service model templates;
receiving an input that selects one of the service model templates for construction of a selected service model, wherein the selected service model represents real-time relationships and characteristics of depicted resources;
identifying external data sources that are used to describe the real-time relationships and characteristics of the depicted resources; and
constructing the selected service model using the identified external data sources.

2. The method of claim 1, further comprising:
performing a business impact analysis based on the real-time characteristics of the depicted resources.

3. The method of claim 1, wherein each service model template comprises a set of rules that defines a dependency relationship between at least two of the depicted resources.

4. The method of claim 1, wherein each service model template comprises a set of rules that map each of the depicted resources to at least one of the external data sources.

5. The method of claim 1, further comprising:
quantifying the real-time characteristics of the depicted resources to create a performance score that describes a health of a total system that utilizes the depicted resources.

6. The method of claim 1, wherein the selected service model is managed by a service provider, and wherein at least part of the selected service model depicts computing resources of a customer of the service provider.

7. The method of claim 6, wherein at least one of the external data sources is a Configuration Management Database (CMDB) that is directly managed by the customer.

8. The method of claim 7, wherein data from the CMDB is obtained by Structured Query Language (SQL) queries to the CMDB.

9. The method of claim 1, further comprising:
setting a performance standard for at least one of the depicted resources.

10. The method of claim 9, further comprising:
visually coding the depicted resources in accordance with each visually-coded depicted resource's performance relative to the performance standard.

11. The method of claim 1, wherein at least one of the depicted resources are assigned to multiple service model templates.

12. The method of claim 1, wherein the input is from a user input into a customer's computer.

13. The method of claim 1, wherein the input is an event that is received from a plurality of data sources, wherein the event describes changes to the plurality of data sources.

14. The method of claim 1, wherein a selected service model comprises dependency rules that define dependency relationships of the depicted resources, wherein the dependency relationships of the depicted resources describe how the depicted resources interact, the method further comprising:
updating the selected service model by re-running the dependency rules when requested by a customer.

15. The method of claim 1, wherein a selected service model comprises dependency rules that define dependency relationships of the depicted resources, wherein the dependency relationships of the depicted resources describe how the depicted resources interact, the method further comprising:
polling the external data sources at predetermined periods, and
updating the selected service model by re-running the dependency rules when the polling detects a change in the external data sources.

16. A data processing apparatus comprising:
a service model construction logic, wherein the service model construction logic comprises:
storage for a plurality of service model templates;
receiving logic for receiving an input that selects one of the service model templates for construction of a selected service model, wherein the selected service model represents real-time relationships and characteristics of depicted resources;
data source identification logic for identifying external data sources that are used to describe the real-time relationships and characteristics of the depicted resources; and
construction logic for constructing the selected service model using the identified external data sources.

17. The data processing apparatus of claim 16, further comprising:
business impact analysis logic for performing a business impact analysis based on the real-time relationships and characteristics of the depicted resources.

18. A computer program product for dynamically creating a service model, the computer program product comprising:
a computer usable medium having computer usable program code embodied therewith, the computer usable program code comprising:
computer usable program code configured for presenting a plurality of service model templates;
computer usable program code configured for receiving an input that selects one of the service model templates for construction of a selected service model, wherein the selected service model represents real-time characteristics of depicted resources;
computer usable program code configured for identifying external data sources that are used to describe the real-time characteristics of the depicted resources; and
computer usable program code configured for constructing the selected service model using the identified external data sources.

19. The computer program product of claim 18, further comprising:
computer usable program code configured for performing a business impact analysis based on the real-time characteristics of the depicted resources.

20. The computer program product of claim 18, further comprising:
computer usable program code configured for quantifying the real-time characteristics of the depicted resources to create a performance score that describes a health of a total system that utilizes the depicted resources.
